(19) United States
(12) Patent Application Publication
(10) Pub. No.: US 2002/0103847 A1
(43) Pub. Date: Aug. 1, 2002

(54) Efficient mechanism for inter-thread communication within a multi-threaded computer system

(76) Inventor: Hanan Potash, Austin, TX (US)

Correspondence Address: Kevin L. Daffer, Conley, Rose & Tayon, P.C., P.O. Box 398, Austin, TX, 78767-0398, US

(21) Appl. No.: 09/776,102

(22) Filed: Feb. 1, 2001

(51) Int. Cl. G06F 9/00

(52) U.S. Cl. 709/107; 709/103

(57) ABSTRACT

A method and system are presented for data communication between multiple concurrently-active threads, preferably executing on a multithreaded processor, such as a precession machine. Compared to existing methods for inter-thread communication, such as calls interrupts, the method described herein reduces overhead associated with context switching and avoids devoting the processor exclusively to the called thread while it executes. The method disclosed herein is therefore believed to offer higher performance for applications such as communications protocol processing, in which there may be a high level of concurrent activity among the threads.

### BACKGROUND OF THE INVENTION

1. Field of Invention

This invention relates to high-speed multithreaded computing, and more particularly, to a high-performance processor for communications.

2. Description of Related Art

In the near future, digital communications networks are expected to undergo tremendous growth and development. As their use becomes more widespread, there is an attendant need for higher bandwidth. To fill this need, present-day copper wire-based systems will gradually be replaced by fiber optic networks. Two key factors enabling this trend will be inexpensive fiber optic links and high-speed distributed protocol processors. The latter are essential in preserving bandwidth while doing the protocol processing tasks. Such tasks are associated with all the OSI (or similar) models of processing a protocol stack, and include basic layers (e.g., physical, network and transport, MAC layer, TCP layer, IP layer), as well as all the compound layers involved in doing ATM over SONET, voice over IP, etc. Additional tasks associated with protocol processing include routing, provisioning, QoS (quality of service), as well as interfacing between dissimilar protocols, such as SONET, Ethernet, Fiber Channel and FireWire.

Protocol processors are a type of high-speed, highly pipelined computer, optimized for fast context switching and containing additional specialized communications-oriented instructions or specialized instruction set(s). These features allow the protocol processors to operate efficiently within a network containing other similar processors implementing various communications protocols.

Because of the fast execution speed of modern processors, a multitasking computer gives the appearance of running several tasks concurrently. However, since most processors can only do one thing at a time, the tasks do not actually execute simultaneously. Instead, each task receives the processor's attention periodically during an interval called a “time-slice.” Between time-slices, the processor must change context. That is, the current register contents, program counter, status, etc. of task must be saved before the task is suspended, and restored before it can resume execution. Since context switching constitutes overhead, it must be done as efficiently as possible in a high-speed multitasking processor.

Part of the overhead associated with context switching is due to the isolation between individual tasks imposed by the operating system that manages the tasks. In order to preserve system integrity, the operating system allocates resources, such as memory space, files, etc., to each task. During execution, a task is allowed access only to its own resources. This provides a measure of protection against tasks interfering with one another, but unfortunately, complicates context switching. Furthermore, a task may slow the overall operation of the system by its inefficient use of system resources. Suppose, for example, that the system printer is dedicated to a specific task. Since the printer is typically much slower than the processor, the task may spend the majority of its time waiting for the printer. Consequently, during that task's time-slice, the processor may be completely idle, yet unavailable for other tasks.

For many applications, multithreading is an efficient alternative to multitasking. A thread, sometimes called a lightweight process, may be defined as the basic unit of processor utilization. Compared to a task, a thread requires a minimum of system resources; a program counter, a register set and stack space. In contrast to a task, it shares code, data, and various operating system resources, such as open files, with peer threads. This greatly simplifies context switching. A task may be comprised of multiple threads, and because the threads share system resources, they may execute concurrently during the task's time-slice. This allows more efficient utilization of the processor. Returning to the previous example, if one of the threads in a multithreaded task has to wait for the printer, the task's other threads can continue to execute.

The architecture of a computer can be optimized for multithreading. One of the approaches to the design of multithreaded computers is the “precession machine” (also known as a “commutator” architecture). In the precession machine approach to multithreaded processing, all the currently executing threads may be active simultaneously. The processor services the threads in a prescribed sequence, with each thread being allotted a fixed time-slice. Out of the total number of processor cycles allocated for the entire set of active threads, the number of cycles allotted to any particular thread represents that thread's time-slice. The sum of the time-slices for all the active threads is referred to herein as the “precession cycle time.” Advantageously, the precession cycle time is consistent and predictable. Each thread has a dedicated set of registers, within which its context is preserved. Since there is no need to swap these data to memory, context switching can be very fast, to the point that context switching occurs between two consecutive cycles with zero time penalty for context switching.

The precession machine architecture has three principal advantages compared to the conventional single-threaded computer architecture: interleaved operation, a simplified memory interface, and real time capability. Interleaved operation refers to the use of multiple banks of memory that are accessed in sequence by the active threads. Using interleaved operation, the throughput of the computer is limited by the processor speed, rather than the (generally slower) access time of the memory. A simplified memory interface is another advantage of the precession machine architecture. Since each thread has its own dedicated register set, a data cache is not required in a precession machine multithread computer. This prevents problems associated with aliasing. Aliasing can occur when multiple processors share a memory resource, such as a data cache. Suppose, for example, that processor “A” temporarily stores a value in a shared cache location, creating an alias to the original memory location. Further suppose that, based on some computation, processor “A” updates the value in the cache then, several cycles later, updates the original memory location. Now, if processor “B” reads the value from memory after it has been put in cache but before the update, it will read the wrong alias value. Clearly, if the value is something like an address pointer, serious problems can result. Of course, measures can be taken to prevent aliasing, but such protection generally adds overhead to the system.

Aliasing is avoided in a precession machine, since a data cache is not needed. Furthermore, there is no need for the complex arbitration logic ordinarily required to maintain cache coherency. The precession machine architecture is also very well suited for real time applications, since thread timing is inherently predictable.

It is often necessary in a multithreaded environment for the various threads to exchange information or commands with one another. A common way of accomplishing this in a conventional single-threaded computer is for one task to “call” another. The operating system is customarily invoked to activate the called task, with some dedicated location provided for data to be passed from the calling task. Clearly, the overhead associated with operating system intervention and the fact that the calling task must be deactivated while the called task executes are disadvantages of this approach. A second method for inter-thread communication is through the use of interrupts. An interrupt causes a faster context switch than a call because it makes use of special hardware features in the processor, such as an interrupt vector table. Each entry in the vector table is the address of a software routine associated with a particular interrupt (commonly known as an “Interrupt Service Routine” or “ISR”). For example, a processor may receive interrupts from external sources, such as a keyboard or mouse, as well as internal sources, such as a timer. For each potential interrupt source, there is an ISR designed to respond to the interrupt. Associated with every interrupt is an entry in the vector table, containing the address of the corresponding ISR. When an interrupt occurs, the processor finds the location in the vector table corresponding to the interrupt and performs an immediate jump to the address contained there. Because the interrupt vector table and associated logic are implemented in hardware, interrupt processing is generally much faster than inter-task calls. However, it is still necessary to deactivate whatever task is executing when the interrupt occurs, in order to devote system resources to the ISR. This also entails some overhead, due to the need to save and restore the context so that processing can be resumed following the interrupt. Therefore, as a method of inter-thread communication, interrupts suffer from several drawbacks.

Thus, while multithreading may offer significant performance advantages over multitasking, existing options for inter-thread communications demand too much processor intervention and may limit any potential performance gains. In view of these disadvantages, it would be desirable to have an efficient mechanism for inter-thread communication in a multithreaded or a multiprocessor environment.

### SUMMARY OF THE INVENTION

The problems outlined above are in large part solved by a system and method for data communication between multiple concurrently-active threads. In an embodiment of this system and method, active threads transmit data to each other using a shared memory resource, and get each other's attention using Attention Registers. Each thread has an Attention Register. The Attention Registers consist of a set of flags, which indicate who wants the thread's attention. There is a flag for every one for each of the active threads, and also flags for external devices. Thus, if thread A wants to communicate data to thread B, it first typically places the data in a prescribed location in memory, then sets the flag corresponding to thread A in the Attention Register of thread B to get thread B's attention. It may place no data at all in very simple protocols, or use a pointer to the data location in complex protocols. When thread B polls its Attention Register, the set flag indicates that it has been contacted by thread A, so it retrieves the data from memory. Furthermore, the polling is typically done by a single instruction using hardware that extracts the highest priority flag, rather than by sequentially polling each flag.

A significant benefit to the use of Attention Registers is that thread A is not forced to suspend execution while the processor devotes itself to thread B. Furthermore, there is no overhead associated with saving and restoring the context of thread A. These are important advantages over the traditional mechanism of inter-thread calls, since multithreaded processing is not impeded during inter-thread communication.

A system is disclosed herein for data communication among multiple active threads executing on a computer processor. According to this system, an Attention Register is associated with each active thread, the Attention Registers comprising a set of flags corresponding to each of the threads. The flags in the Attention Register are preferably arranged in order of the priority of their respective threads. The system further includes Set Attention and Get Attention instructions, executable by the processor, for setting and reading flags in the Attention Registers. The Set Attention instruction is used by one thread to get the attention of another thread. When executed by thread A with an operand specifying thread B, the Set Attention instruction sets a flag corresponding to thread A in the Attention Register of thread B. The Get Attention instruction is used by one thread to find out if its attention is requested by another thread. Thread B executes a Get Attention instruction to read its Attention Register and obtain the identifier of the highest priority thread whose flag is set.

In a preferred embodiment, the system further comprises a Polling Mask Register and Interrupt Mask Register associated with each active thread. The Polling Mask Register may be used to mask specific flags in a thread's Attention Register; when the Get Attention instruction is executed, it will ignore the masked flags. The Interrupt Mask Register is used to control interrupt generation by specific flags in the Attention Register. If a flag is not masked, setting it interrupts the associated thread. Flags are normally masked, so they must be polled using the Get Attention instruction. In addition to flags corresponding to active threads, some flags in the Attention Register may be devoted to either External Attentions or Programmed Attentions. Setting an External Attention flag causes the processor to raise a signal line to the corresponding external processor or device, which in turn sets the corresponding attention flag in the corresponding processor. A Programmed Attention flag serves as a call request, to indicate that the thread is ready to be called by another thread owning the Attention Register, or by one routine in the thread's program activating another routine in the thread's program. This feature is typically used to simulate a program section that has yet to be developed, or an external device that has yet to be connected and tested.

A method for data communication among multiple active threads is also contemplated herein. An embodiment of the method consists of a first thread transmitting data to a second thread by placing the data in memory, then setting a flag corresponding to the first thread in an Attention Register belonging to the second thread. The second thread polls its Attention Register and reads the flag set by the first thread, then, in response, retrieves the data from memory. The method further comprises using a polling mask to selectively ignore specific Attention Register flags, and an interrupt mask to control which flags are able to generate interrupts. The method still further comprises including External Attention flags and Programmed Attention flags in the Attention Register. According to the method, External Attention flags are used to control signal lines to external devices, and Programmed Attention flags are used to request calls from other threads.

The system and method described herein are believed to offer improved performance over existing approaches to inter-thread communication such as calls and interrupts when used with multithreaded processors in applications in which the threads have a high level of concurrent activity.

While the discussion here addresses multithreaded machines and communication among threads all the discussions are equally applicable to a cluster of microprocessors or a cluster of microprocessor “cores” on one or more chips. Furthermore, while the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### BRIEF DESCRIPTION OF THE DRAWINGS

Other objects and advantages of the invention will become apparent upon reading the following detailed description and upon reference to the accompanying drawings in which:

FIG. 1 illustrates the “commutator” analogy to the operation of a precession machine-type multithreaded processor;

FIGS. 2a and 2b illustrate the bank of Attention Registers and a detailed view of an Attention Register, according to an embodiment of the method disclosed herein;

FIG. 3 depicts the sequence of events corresponding to an inter-task call; and

FIG. 4 depicts the sequence of events corresponding to data communication according to the method disclosed herein.

### DETAILED DESCRIPTION OF THE PREFERRED EMBODIMENTS

For many high-speed computing applications, such as communications protocol processing, multithreading is an efficient alternative to multitasking. A conventional process (i.e., a task) has a single flow of control, comprising a sequence of instructions executed by the process. In a multithreaded process, there are multiple scheduled flows of control called “threads.” By splitting the work done by the process into smaller pieces, individual threads can pursue each piece concurrently. Every thread has its own program counter, register set and stack space. However, unlike a task, a thread shares its code space, data space, and various operating system resources, such as open files, with peer threads. Hence, context switching between threads is considerably less complicated than for tasks, since no memory management is involved. A task may be comprised of multiple threads, and because the threads share system resources, they may execute concurrently during the task's time-slice. This allows more efficient utilization of the processor. A conventional multitasking processor may be characterized as a multithreaded machine in which the tasks are single-threaded.

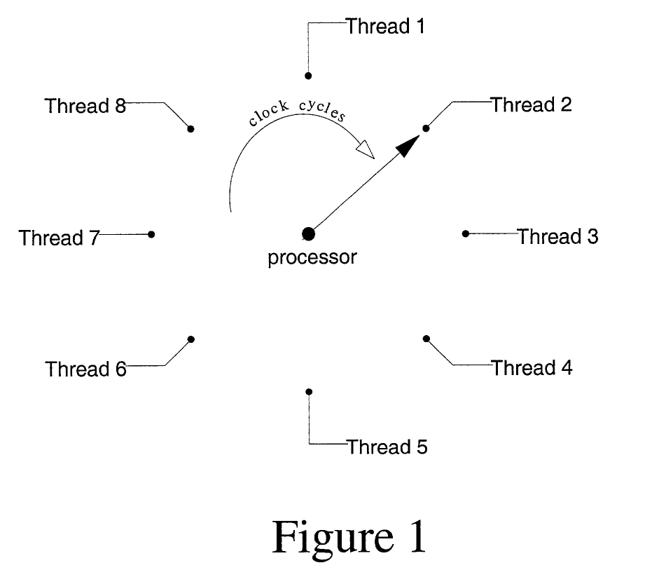

There are computer architectures that are optimized for multithreaded operation. One such architecture is the “precession machine.” FIG. 1 represents the action of the processor in a precession machine sequentially servicing eight active threads. The analogy to the distributor in an automobile engine is obvious, and explains why the precession machine is also referred to as a “commutator” architecture. Thread 2 is shown as the currently executing thread. Each thread is allotted a fixed number of cycles out of the total number of cycles allocated—this is its time-slice. The time-slice is typically evenly distributed. This means that the processor devotes one cycle to executing instructions in thread 2, before moving to thread 3. For example, if Thread 2 is allocated a time-slice of 8 out of 64 allocated cycles, the optimal approach is for the processor to devote every 8th cycle to Thread 2—as opposed to devoting 8 consecutive cycles to Thread 2, then devoting the remaining 56 cycles to other threads. A thread executes within its own execution context, comprising a dedicated program counter, register set, status, etc. As the commutator moves from one thread to the next, it performs a context switch. However, since context is preserved in a precession machine, a context switch may be accomplished without saving/restoring the present context to/from (relatively slow) system memory. Instead, context is preserved in registers dedicated to each thread. This typically avoids the entire cycle(s) time overhead associated with context switching in a conventional processor. In FIG. 1, after the processor has serviced each of the threads for its allotted time-slice, it returns to thread 2. The interval required for the processor to complete its cycle (i.e., service all of the threads) is the precession cycle time.

The precession machine offers potentially higher performance than a conventional single-threaded processor. However, real world applications frequently involve more than concurrent execution of multiple threads. In many cases, a high degree of inter-thread communication is also necessary. This is important in applications such as communications protocol processing, in which several threads may be working together on a task and need to exchange data, or otherwise interact with each other. In such a situation, it is impossible to achieve maximum efficiency from the precession machine without some efficient means of inter-thread communication.

The traditional mechanisms for inter-task communication (i.e., “calls” and interrupts), used in single-threaded computers are unsuitable for use in a high performance multithreaded machine. Significant overhead is associated with saving and restoring the context of a thread that calls another thread or is interrupted. Depending on the level of inter-thread communication required, this overhead can account for an unacceptable share of the total processor execution time.

The method described herein addresses the limitations of these conventional techniques for inter-thread communication. The use of Attention Registers, as described in more detail below, allows threads to communicate with less processor intervention than required by previous approaches. An embodiment of this method is described below. For purposes of explanation, the method is described in the context of a precession machine, but it should be understood that it is equally applicable to other computer architectures, for example a cluster of microprocessors or a cluster of microprocessor cores on one or more chips.

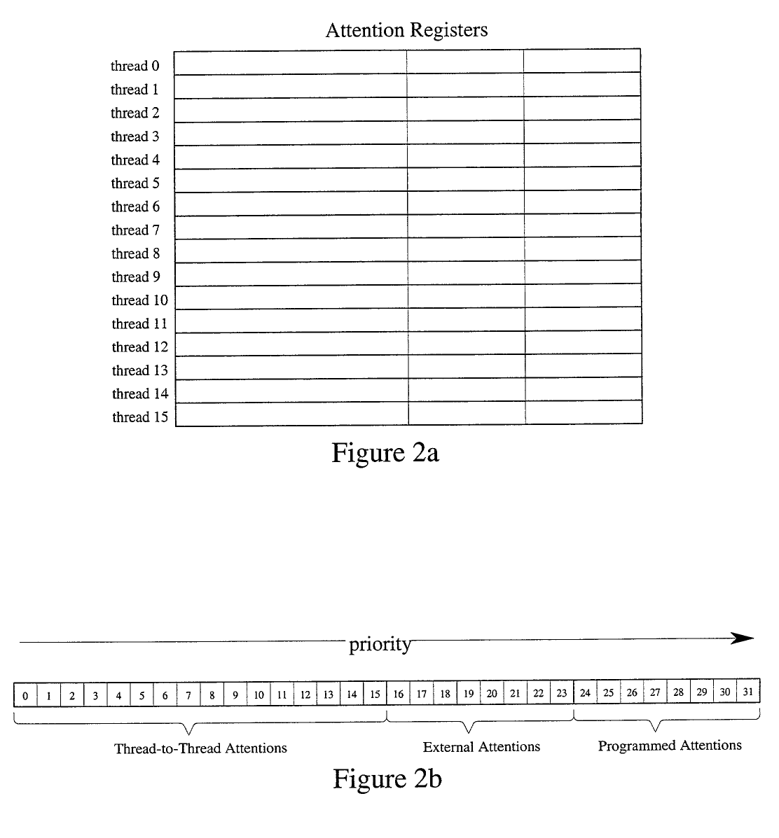

In the exemplary embodiment, the computer is a precession machine with 16 active threads. Each thread has its own execution context, comprising a program counter and a set of 32 registers. Associated with each thread is a 32-bit Attention Register, with the 16 Attention Registers comprising a table, as illustrated in FIG. 2a. It can be seen in FIG. 2b that each Attention Register contains 32 flags. These flags are arranged in order of decreasing priority from left to right, so that flag 0 has the highest priority and flag 31 the lowest. Flag 0-flag 15 are reserved for Thread-to-Thread Attentions, and each flag is associated with one of the 16 active threads. Threads use these flags to communicate with one another. When one thread wishes to communicate with another, the sender first alerts the intended recipient by setting the appropriate flag in his Attention Register. For example, when flag 9 in the Attention Register of thread 4 is set, it indicates that thread 9 is requesting the attention of thread 4. Flag 16-flag 23 are related to External Attentions; when one of these 8 flags is set, it indicates that an external device or processor has requested the attention of the corresponding thread. An external device may be a separate device connected to the processor (or processor core, in the case of multiple devices on a single chip), such as an I/O device, or another processor. The remaining 8 flags, flag 24-flag 31, are used for Programmed Attentions. Programmed Attention flags are set in the thread's own Attention Register, and may be used in software development, to simulate an expected response from an as yet unwritten thread.

The processor's instruction set includes special “Set Attention” and “Get Attention” instructions. The “Set Attention” instruction sets a flag in the Attention Register for an intended recipient, according to the contents of an operand in the instruction. For example, if the operand of a Set Attention instruction in thread A contains the identifier of thread B (i.e., 0-15), then the flag corresponding to thread A is set in the Attention Register of thread B. If instead, the operand corresponds to an External Attention (i.e., 16-23), then an attention line to the corresponding external device will be activated. Alternatively, if the operand corresponds to a Programmed Attention (i.e., 24-31), then a flag is set in thread A's own Attention Register. A complementary “Get Attention” instruction polls a thread's Attention Register and returns the identifier of the highest-priority thread (or external device) requesting the thread's attention. The flag corresponding to the highest-priority thread is typically automatically cleared when the Attention Register is polled. The Set Attention and Get Attention instructions allow threads to contact each other via the Attention Registers. Messages or data to be passed from one thread to another are placed in a designated area of memory accessible to all the threads. For example, assume thread A has a message for thread B. After writing the message to the designated area of memory, thread A posts a flag in the Attention Register of thread B, by executing a Set Attention instruction. Thread B executes a Get Attention instruction to find that there is a message from thread A, and then retrieves the message from the designated area of memory.

The Programmed Attention flags in the Attention Register serve a special function by providing Call-on-Request capability. Normally, a calling task must have access to some information belonging to the called task to indicate when it is appropriate to make the call. However, this implies the need to inspect memory prior to calling another task, which is an inefficient use of processor cycles. Call-on-Request is an alternative to the normal calling mechanism, in which the called thread posts a request to be called in the Attention Register. For example, when thread B is ready to be called, it uses a Set Attention instruction to set a Programmed Attention flag (i.e., bit 24-31) in its own Attention Register. Now, when thread A wishes to call thread B, it has only to poll thread B's Attention Register until it finds the appropriate flag set, which is typically accomplished in a single processor clock cycle.

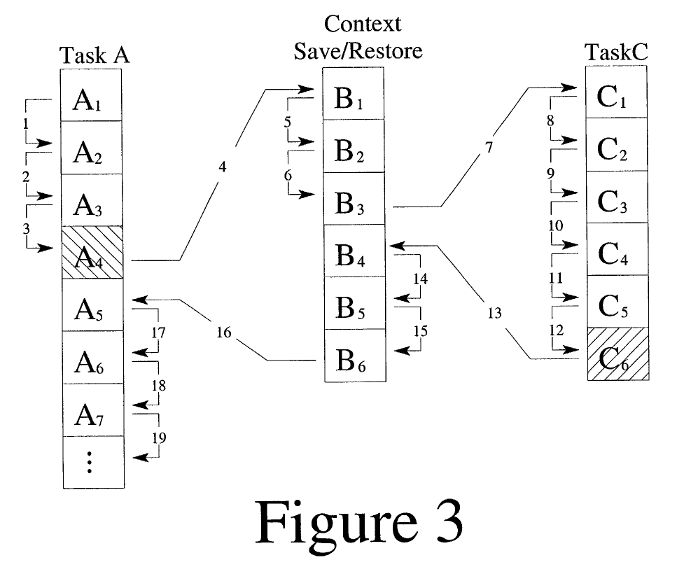

Inter-thread communication by means of the Attention Registers is more efficient than calls or interrupts, based on the amount of processor intervention required. FIG. 3 illustrates a series of events typical in call or interrupt-based inter-task communication, as used in a conventional multitasking computer. Three instruction sequences are shown; in each sequence, the letter identifies the sequence and the subscript the instruction number. Task A communicates information to task C, while instructions B₁-B₆ represent the instruction sequence that saves and restores the context of task A. The numbered arrows show the order in which instructions are executed. Thus, in the first clock cycle, instruction A₁ in task A executes and the program counter advances to instruction A₂. Assume that task A has previously placed data intended for task C in a designated area of memory, and that instruction A₄ makes a call to task C (indicated by the hash pattern). Before the processor can execute the call to task C, however, it must save the context (i.e., program counter, status, general purpose registers, etc.) of task A. Therefore, B₁ is the next instruction following A₄. After task A's context has been saved, execution of task C begins with instruction C₁ during clock cycle 8. Upon its completion in clock cycle 13, task C executes a “Return” instruction to go back to task A (indicated by the hash pattern). However, the original context of task A must first be restored, hence the next instruction to be executed after C₆ is B₄. Finally, after instructions B₄-B₆, execution of task A resumes at instruction A₅.

The description of events for inter-task communication using an interrupt mechanism is similar to that of the call mechanism, except that A₄ in FIG. 3 would not be a “call” instruction, but an instruction resulting in a software-generated interrupt. Referring to FIG. 3 again, the interrupt suspends task A immediately after instruction A₄ is executed, and instructions B₁-B₃ save the context of task A. The interrupt mechanism then activates task C, the intended recipient of the message from task A. Upon completion of task C, instructions B₄-B₆ restore task A's context, and task A resumes execution.

The preceding examples are highly simplified, but reveal why the standard call and interrupt mechanisms employed in conventional computer systems are unsuitable for intensive inter-thread communications. In the first place, the operations associated with saving and restoring context account for a significant amount of the processor's execution time. Therefore, processor efficiency degrades with higher levels of inter-thread communication activity. Secondly, with the standard call and interrupt mechanisms, the processor's resources are exclusively devoted to the called thread while it executes. Consequently, while the called thread is executing, the thread that initiated the call is suspended. This represents a severe handicap for a multithreading system, since it precludes communication between concurrently executing threads.

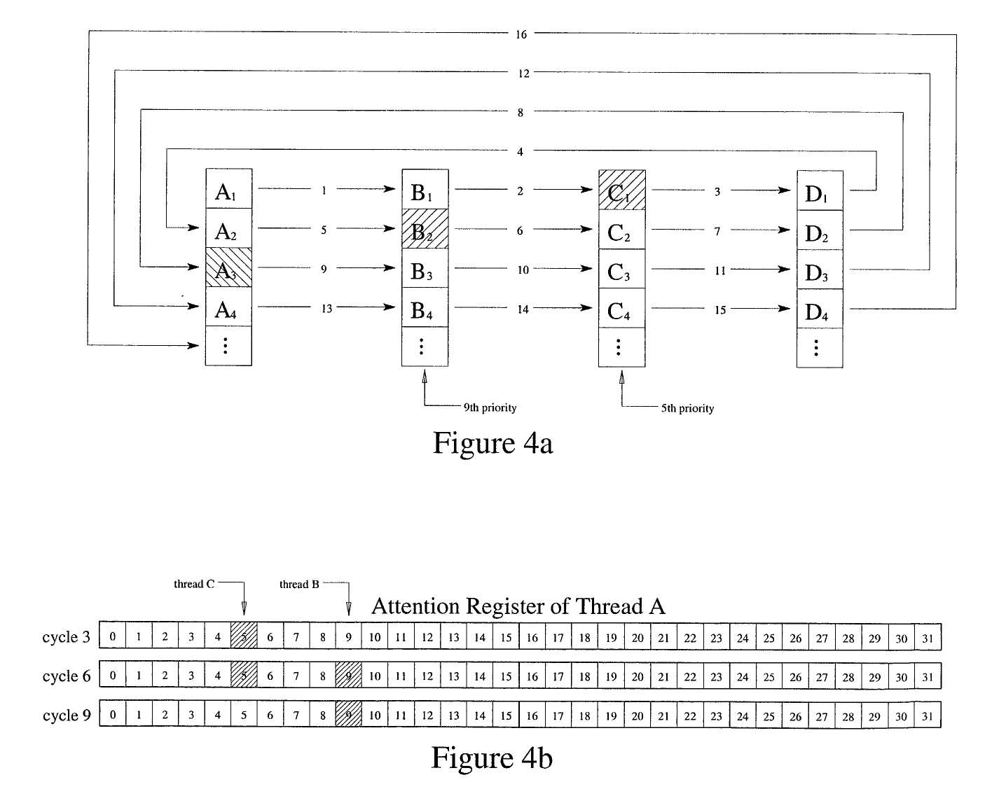

A diagram illustrating inter-thread communication using Attention Registers is shown in FIG. 4a. Four threads are shown, with the individual instructions denoted as before, and the order of execution of the instructions indicated by the numbered arrows. Note that the threads execute in turn, with each thread receiving every fourth processor cycle. Such highly interleaved execution is characteristic of a precession machine architecture, and is advantageous for applications requiring true concurrency among the threads. For the purposes of this example, thread C is assumed to have 5th priority and thread B 9th priority. Therefore, flag 5 corresponds to thread C and flag 9 to thread B in the Attention Register of thread A, as shown in FIG. 4b. During processor cycle 3 in FIG. 4a, thread C executes a Set Attention instruction (indicated by the hash pattern over instruction C₁), with an instruction operand targeting thread A. This causes flag 5 to be set in the Attention Register, as shown in FIG. 4b. If the next instruction to be executed in thread A, A₂, is not a Get Attention instruction, there is no response to the flag. In cycle 6, another Set Attention instruction executed in thread B sets flag 9 in the Attention Register, as shown in FIG. 4b. The next instruction to execute in thread A is a Get Attention instruction. During processor cycle 9, instruction A₃ polls the Attention Register, clearing flag 5 (since it has a higher priority than flag 9) and returning the identifier of thread C. Thread A will retrieve the data sent by thread C from a designated area of memory, and subsequently execute another Get Attention instruction enabling it to detect and respond to flag 9.

In contrast to call and interrupt mechanisms, the method of Attention Registers reduces overhead by not devoting processor cycles to saving and restoring context. Furthermore, since all of the threads remain active throughout communication transactions, inter-thread communication can take place simultaneously with the concurrent operation of multiple threads. This capability is highly advantageous in a communications protocol processor.

In addition to being fast, this operation is highly predictable with regard to the exact time and timing sequence that it takes to communicate between (or among) threads. Timing predictability is crucial in the real-time word of communication processing. This is especially true in the lower (or physical) layers that must adhere to a predictable timing of control signals and data transfer transactions. Response to an incoming signal or transfer must occur no earlier than a prescribed minimum number of cycles and no later than a prescribed maximum number of cycles in order to conform to protocol specifications.

In addition to the Attention Register, each thread also has a set of five special registers, the function of which is discussed below.

32-bit Task ID

32-bit Polling Mask

32-bit Interrupt Mask

32-bit Interrupt Address or Interrupt Address Table base

32-bit Interrupted Location Program Counter

The Task ID Register contains a 32-bit number identifying the task with which the corresponding thread is associated. As stated previously, a task may comprise multiple threads, each of which pursues some component of the task. In some program implementations, one thread may serve several tasks. The Task ID indicates which task the thread is assigned to. The Polling Mask Register is used by a thread to selectively poll its Attention Register. When thread A executes a Get Attention instruction, it receives the identifier of the highest priority thread that has set a flag in thread A's Attention Register. However, thread A may be more concerned with the status of a lower-priority thread. By using a Polling Mask, thread A can ignore specific flags when polling the Attention Register.

Although unsuitable for general inter-thread communication, interrupts are nevertheless a desirable feature in a multithreaded processor, as a minimum response time mechanism for special high-priority communications. As described thus far, communication via Attention Registers depends on the recipient thread polling its Attention Register regularly. Clearly, the time required for thread B to respond to a message posted by thread A is based on how frequently thread B executes a Get Attention instruction. For general purpose messaging, some latency is acceptable. However, for events requiring an immediate response, the flags in the Attention Register can also be used to generate interrupts. For this purpose, each thread has a 32-bit Mask Register and a 32-bit Interrupt Address Register. The bits in the Mask Register correspond to the flags in the Attention Register. Unless it is masked, setting a flag in the Attention Register immediately interrupts the corresponding thread and directs execution to the thread responsible for setting the flag. The Interrupt Address Register contains the address of the interrupt routine, or the base address of the interrupt table pointing to the routines as well as an address in memory to which the context of the thread is saved before executing the interrupt routine. As an example of how the Mask Register is used, suppose thread A has priority 9 and thread B has priority 5, and that thread A executes a Set Attention instruction with “5” contained in the operand. As explained above, this sets flag 9 in the Attention Register of thread B. If bit 9 in the Mask Register of thread B is set, no interrupt occurs, and thread B must poll its Attention Register to discover that flag 9 has been set. On the other hand, if bit 9 is not set, thread B is immediately interrupted. Thus, depending on whether they are masked, Attention Register flags may either be read using the Get Attention instruction, or used to create an interrupt, or both. In the present embodiment, thread 0 is the highest priority thread and contains a full set of interrupt service routines. The system architect may use a single set of interrupt service routines for all threads, or choose to have an interrupt service routine set for each thread. Flag 0 in the Attention Register cannot be masked, so thread 0 can preemptively interrupt any other thread. A 32-bit Interrupt Location Program Counter preserves the value of the program counter for the interrupted thread while the interrupt routine executes. Upon returning from the interrupt routine, the interrupted thread uses the Interrupt Location Program Counter to resume execution exactly where it left off.

The present method takes advantage of the fast context switching capability of the precession machine to reduce the overhead involved in inter-thread communication. This is believed to be an improvement over traditional methods involving calls or interrupts, for applications such as communications protocol processing, in which there is a high degree of concurrent thread activity.

It will be appreciated by those skilled in the art having the benefit of this disclosure that this invention is believed to present an architecture and method for data communication between multiple concurrently active threads in a multithreaded computer. Further modifications and alternative embodiments of various aspects of the invention will be apparent to those skilled in the art in view of this description. For example, it should be clear that the principles disclosed herein could also be applied to communication between multiple single-threaded processors. Such details as the number of threads and registers and the number of clock cycles in the precession cycle as described herein, are exemplary of a particular embodiment and may be altered in other embodiments. It is intended that the following claims be interpreted to embrace all such modifications and changes and, accordingly, the specification and drawings are to be regarded in an illustrative rather than a restrictive sense.

What is claimed is:

1. A system for data communication between a plurality of threads concurrently executing on a computer processor, comprising:
an attention register associated with each thread, said attention register comprising flags corresponding to each thread;
a set attention instruction that, when executed by a first thread with an operand designating a second thread, sets a flag corresponding to the first thread in the attention register of the second thread;
a get attention instruction that when executed by the second thread, returns the identifier of the first thread corresponding to a set flag in the attention register of the second thread; and
a memory resource wherein data may be placed by the first thread and retrieved by the second thread, in response to a flag set by the first thread in the attention register of the second thread.

2. The system as recited in claim 1, further comprising a polling mask register associated with each thread, said polling mask register comprising mask bits corresponding to each of the flags in the attention register, such that when a mask bit is set the get attention instruction ignores the corresponding flag.

3. The system as recited in claim 1, further comprising an interrupt mask register associated with each thread, said interrupt mask register comprising mask bits corresponding to each of the flags in the attention register, such that setting a bit in the attention register interrupts the associated thread unless the corresponding mask bit is set.

4. The system as recited in claim 1, further comprising an interrupted location program counter associated with each thread, to which an interrupted thread saves its program location prior to servicing an interrupt, and from which the interrupted thread restores its program location, allowing it to resume execution after servicing the interrupt.

5. The system as recited in claim 1, further comprising a task ID register associated with each thread, said task ID register identifying the task to which said each thread is connected.

6. The system as recited in claim 1, wherein the attention register further comprises external attention flags corresponding to a device coupled externally or internally to the computer processor, such that setting an external attention flag raises a signal to the associated device.

7. The system as recited in claim 1, wherein the attention register further comprises programmed attention flags, such that setting an attention flag indicates that the thread with which the attention register is associated is ready to be called by another thread.

8. The system as recited in claim 1, wherein the flags in the attention register are arranged in order of priority.

9. The system as recited in claim 1, wherein when the get attention instruction returns the identifier of a thread corresponding to a set flag in an attention register, it also clears the flag.

10. The system as recited in claim 1, wherein when a thread responds to an interrupt resulting from a set flag in its attention register, it also clears the flag.

11. A method for data communication between a plurality of threads executing concurrently on a computer processor, comprising:
a first thread transmitting data to a second thread by setting a flag corresponding to the first thread in an attention register belonging to the second thread; and
the second thread polling its attention register and reading said set flag, and responding by several means which may include retrieving the data from memory.

12. The method as recited in claim 11, further comprising the use of a polling mask, such that when masked, the flag is ignored by the second thread.

13. The method as recited in claim 11, further comprising the use of an interrupt mask, such that when unmasked, the flag causes the second thread to be interrupted.

14. The method as recited in claim 11, further comprising including externally or internally connected attention flags in the attention register, and responding to a set external attention flag by raising a signal line to an associated external device.

15. The method as recited in claim 11, further comprising including programmed attention flags in the attention register, and interpreting a set programmed attention flag as a call request by the thread owning the attention register.

16. The method as recited in claim 11, wherein a set flag in the attention register is cleared when it is read or when it causes the associated thread to be interrupted.

17. The method as recited in claim 11, wherein a Task ID is associated with each thread.

18. The method as recited in claim 11, wherein the plurality of threads is prioritized, and wherein interrupts are serviced by the thread with the highest priority.

19. A method for data communication between a plurality of threads executing concurrently on a computer processor, comprising:
a first thread transmitting data to a second thread by setting a flag corresponding to the first thread in an attention register belonging to the second thread; and
the second thread being interrupted by the attention register, reading said set flag and responding by several means, which may include retrieving the data from memory.

20. The method as recited in claim 19, further comprising the use of a polling mask, such that when masked, the flag is ignored by the second thread.

21. The method as recited in claim 19, further comprising the use of an interrupt mask, such that when unmasked, the flag causes the second thread to be interrupted.

22. The method as recited in claim 19, wherein the attention register further comprises internally connected and externally connected attention flags, and wherein responding to a set external attention flag comprises raising a signal line to an associated external device.

23. The method as recited in claim 19, wherein the attention register further comprises programmed attention flags, and wherein responding to a set programmed attention flag comprises interpreting the flag as a call request by the thread owning the attention register.

24. The method as recited in claim 19, wherein a set flag in the attention register is cleared when it is read or when it causes the associated thread to be interrupted.

25. The method as recited in claim 19, wherein a Task ID is associated with each thread.

26. The method as recited in claim 19, wherein the processor may poll the interrupt lines through a Get Attention instruction or other mechanism.
